(19) United States
(12) Patent Application Publication
(10) Pub. No.: US 2015/0109911 A1
(43) Pub. Date: Apr. 23, 2015

(54) METHOD OF MANAGING POLICY FOR REDUCING NETWORK LOAD IN OVERLOADED AREA, SYSTEM AND RECORDING MEDIUM THEREOF

(71) Applicant: IDEAWARE INC., Seongnam-si, Gyeonggi-do (KR)

(72) Inventor: Yang Meong Cha, Seongnam-si (KR)

(73) Assignee: IDEAWARE INC., Seongnam-si, Gyeonggi-do (KR)

(21) Appl. No.: 14/397,157

(22) PCT Filed: Jun. 11, 2013
(86) PCT No.: PCT/KR2013/005120

§ 371 Date: Oct. 24, 2014

(30) Foreign Application Priority Data
Jun. 14, 2012 (KR) 10-2012-0063502
Jun. 14, 2012 (KR) 10-2012-0063505
Jun. 14, 2012 (KR) 10-2012-0063506

(51) Int. Cl. H04W 28/02

(52) U.S. Cl. CPC H04W 28/0289
USPC 370/230

(57) ABSTRACT

The present invention relates to a method of managing a policy for reducing a network load in an overloaded area, a system and a recording medium thereof. The system includes a communication section for receiving information of an area in which overloaded occurs at a specific time slot from a server over a communication network and a processing section for transmitting the information of the overloaded area at a specific time, that is received by the communication section, to a policy agent installed in a wireless terminal, and processing so that the policy agent blocks network connection of one or more applications in the wireless terminal in case the current time and position of the wireless terminal correspond to the time and position according to the information of the overloaded area at a specific time.

### BACKGROUND OF THE INVENTION

1. Technical Field

The present invention is to reduce wireless network load in an overloaded area, by autonomously blocking network connection of the applications for wireless terminal located in the overloaded area at the specific time slot.

2. Description of the Related Art

After supplying smart-phones, patterns using a wireless terminal for individuals are abruptly changed from voice communication to data communication.

In FIG. 1 shown as mobile (wireless) data traffic index, mobile traffics are expected to increase to 26 times in the next 10 to 15 years, and mobile data amount of 15 MB used by individuals per day has been used in 2010 but mobile data amount of 1 GB will be used in 2020.

The increase of the mobile traffics directly effects on profitability and service quality of the mobile-service company and accompanies a service provider, that is, a mobile-service company's equipment expansion, and therefore profit aggravation is inevitable and a user using a mobile network has service dissatisfaction due to data communication velocity delay.

Therefore, the mobile-service company must effectively use network infra to reduce investment burden and to guarantee service quality and an alternative guaranteeing predictability and real-time control is needed due to the limits of current solutions.

Meanwhile, as FIG. 2 shows, mobile network congestions are mainly caused by unnecessary use of network by the applications installed in wireless terminal devices, numerous wireless terminal devices concentrated in a limited space (e.g. stadium, subway, etc.), and using patterns of users.

Data communication is delayed according to rapid increase of network availability for a specific area in the case that a number of the wireless terminal are driven to the defined areas such as stadiums, subways, etc. Therefore, there is a problem in that the applications disposed at the wireless terminal further increase network traffic while continuously performing network connection for data communication connection on a second basis.

In order to solve much cost consumption of the mobile communication company due to network jam and service dissatisfaction for users of the wireless terminal, a method for controlling the network connection by a plurality of applications disposed at the wireless terminal is absolutely needed, but there are no solutions for this.

### SUMMARY OF THE INVENTION

An object of the present invention for solving the above-mentioned problems is that it provides a method, a system and a recoding medium for smoothly controlling and adjusting a network usage in an overloaded area at a specific time slot, and improving data communication environment of the user and reducing battery consumption by network jam removal while reducing network expansion cost of a mobile communication company and improving service quality. To achieve this, a policy server transmits information of an overloaded area at a specific time to a policy agent installed in a wireless terminal, and processes so that the policy agent blocks network connection of one or more applications in the wireless terminal in case the current time and position of the wireless terminal correspond to the time and position according to the information of the overloaded area at a specific time.

Technical tasks to achieve in the present invention are not limited to the above-mentioned technical tasks. Other technical tasks which are not mentioned may be clearly understandable for those who skilled in the art of the present invention from the following description.

A system of managing a policy for reducing a network load in an overloaded area according to the present invention, comprising: a communication section for receiving information of an area in which overloaded occurs at a specific time slot from a server over a communication network; and a processing section for transmitting the information of the overloaded area at a specific time, that is received by the communication section, to a policy agent installed in a wireless terminal, and processing so that the policy agent blocks network connection of one or more applications in the wireless terminal in case the current time and position of the wireless terminal correspond to the time and position according to the information of the overloaded area at a specific time.

According to an aspect of the present invention, the communication section further receives information of an area in which the overload is released at a specific time slot from a server over a communication network, and the processing section transmits the information of the overload-released area at a specific time, that is received by the communication section, to the policy agent installed in the wireless terminal, and processing so that the policy agent releases the network connection blocking for one or more applications in the wireless terminal.

According to another aspect of the present invention, the processing section transmits identification information of one or more applications allowed the network usage irrespective of the position within the overloaded area at the specific time slot to the policy agent.

A method of managing a policy for reducing a network load in an overloaded area according to the present invention, comprising: receiving, in a policy server, information of an area in which overloaded occurs at a specific time slot from a server over a communication network; transmitting, in the policy server, the information of the overloaded area at a specific time, that is received by the communication section, to a policy agent installed in a wireless terminal, and processing so that the policy agent blocks network connection of one or more applications in the wireless terminal; receiving, in the policy server, information of an area in which the overload is released at a specific time slot from a server over a communication network; and transmitting, in the policy server, the information of the overload-released area at a specific time, that is received by the communication section, to the policy agent installed in the wireless terminal, and processing so that the policy agent releases the network connection blocking for one or more applications in the wireless terminal.

According to an aspect of the present invention, the method of managing a policy for reducing a network load in an overloaded area, further comprising: transmitting identification information of one or more applications allowed the network usage irrespective of the position within the overloaded area at the specific time slot to the policy agent.

Also, the present invention includes a computer-readable recording medium for recording programs to perform each of the steps.

According to an embodiment of the present invention, the present invention may block unnecessary network connection attempts itself performed by the applications installed in the wireless terminal that may not transmit and receive data even on attempting the network because of being positioned in an overloaded area at a specific time slot.

According to another embodiment of the present invention, the present invention may block unnecessary network connection attempts itself performed by the applications installed in the wireless terminals concentrated in the overloaded area, thereby to solve problems of network overload and optimize network usage at wireless terminal stages.

According to further another embodiment of the present invention, mobile-service Company's network expansion cost may be minimized by optimizing the network usage.

According to further yet another embodiment of the present invention, on optimizing network usage, it is possible to minimize dissatisfaction for the wireless terminal's user caused by data communication delay, etc. and to greatly reduce battery consumption for the wireless terminal.

### BRIEF DESCRIPTION OF THE DRAWINGS

The following drawing drawings attached to the present specification illustrates an exemplary embodiment of the invention, and serves to further understand the technical idea of the invention along with a detailed description of the invention. Therefore, the invention is not limited to matters described in the drawings.

FIG. 1 shows a view illustrating a mobile (wireless) data traffic indexes.

FIG. 2 shows a view illustrating main factors causing network congestions of the conventional technology.

FIG. 3 shows a communication network or network connection according to an embodiment of the present invention.

FIG. 4 shows sub-configurations for a policy server according to the embodiment of the present invention.

FIG. 5 shows sub-configurations for a wireless terminal according to the embodiment of the present invention.

FIG. 6 shows a process of managing a policy for blocking a network usage in an overloaded area at a specific time slot according to the embodiment of the present invention.

FIG. 7 shows a process of managing a policy for releasing the network usage blocking in the overload-released area at a specific time slot according to the embodiment of the present invention.

FIG. 8 shows a process of blocking network connection for the wireless terminal positioned in the overloaded area at the specific time slot according to the embodiment of the present invention.

FIG. 9 shows a process of releasing the network connection blocking for the wireless terminal positioned in the overload-released area at the specific time slot according to the embodiment of the present invention.

FIG. 10 shows a process of releasing the network connection blocking for the wireless terminal deviated from the overloaded area according to another embodiment of the present invention.

FIG. 11 shows a process of releasing the network connection blocking for the wireless terminal in case of deviation from the specific time slot according to the other embodiment of the present invention.

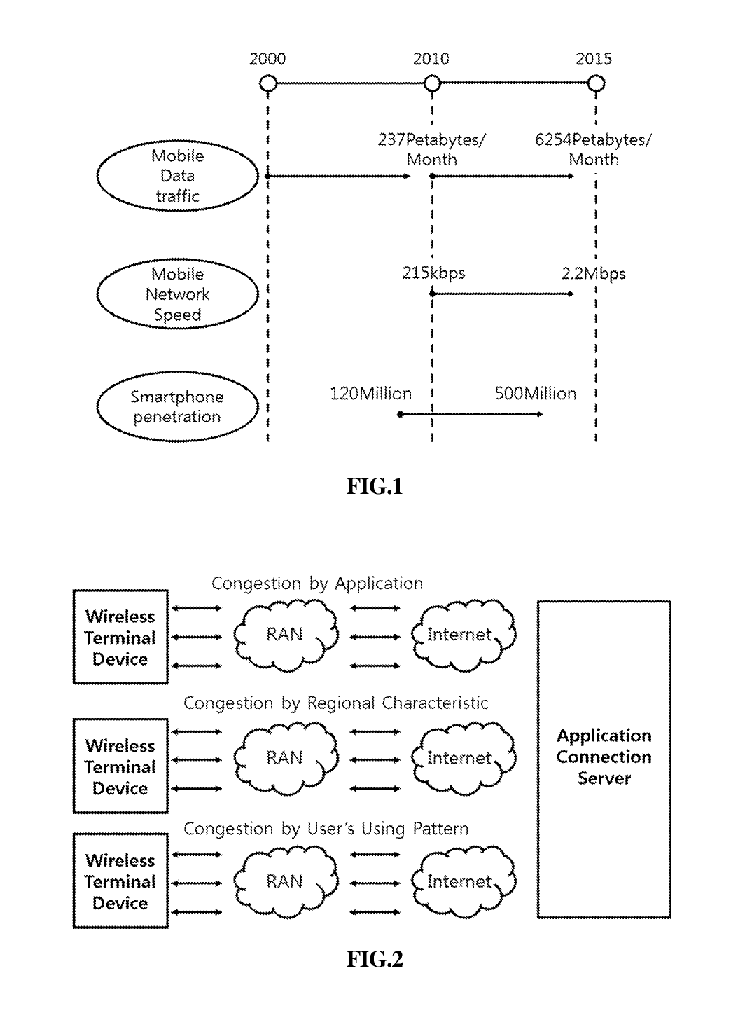

### DESCRIPTION OF THE PREFERRED EMBODIMENTS

Hereinabove, although the present invention is described by specific matters such as concrete components, and the like, embodiments, and drawings, they are provided only for assisting in the entire understanding of the present invention. The specified matters and embodiments and drawings such as specific apparatus drawings of the present invention have been disclosed for illustrative purposes, but are not limited thereto, and those skilled in the art will appreciate that various modifications, additions and substitutions are possible from the disclosure in the art to which the present invention belongs. In describing exemplary embodiments of the present invention, well-known functions or constructions will not be described in detail since they may unnecessarily obscure the understanding of the present invention. Further, the terminologies specifically defined in consideration of the configuration and functions of the present invention may be construed in different ways by the intention of users and operators. Therefore, the definitions thereof should be construed based on the contents throughout the specification. Therefore, the definitions thereof should be construed based on the contents throughout the specification.

It will be apparent to those skilled in the art that substitutions, modifications and variations can be made without departing from the spirit and scope of the invention as defined by the appended claims and can also belong to the scope of the invention.

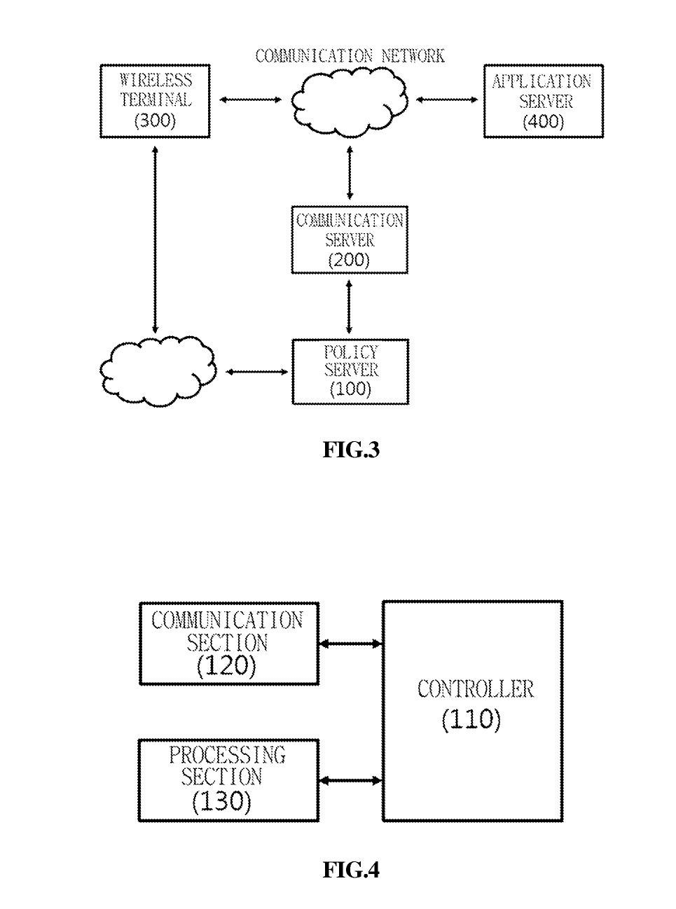

FIG. 3 shows a communication network or a network connection according to an embodiment of the present invention.

In more detail, FIG. 3 shows configurations that a system of managing a policy for reducing network load, the system including a policy server 100, are connected to a communication server 200 and a user's wireless terminal 300 through a communication network or a network to control network connection of applications for the wireless terminal 300 positioned in an overloaded area, where network overload occurs, at a specific time slot.

The system for managing the network load reduction policy, according to the present invention, may have various configurations according to implement method and connection method of the communication network.

For example, the policy server 100 may be connected to the communication server 200 through the communication networks or networks, or directly connected to the communication server 200, or included in the communication server 200.

The policy server 100, that is a core element of the system for managing network load reduction policy according to the present invention, receives information of an area in which overload occurs at the specific time slot from the communication server 200 over the communication network. And then, the policy server 100 transmit the information of the overloaded area at the specific time slot to a policy agent installed in the wireless terminal 300. Therefore, the policy agent blocks network connection of one or more applications in the wireless terminal, in case the current time and position of the wireless terminal 300 corresponds to the time and position according to the information of the overloaded area at the specific time slot.

According to the present invention, the policy server 100 further receives information of an overload-released area, where the network overload is released at the specific time slot, from the communication server 200 over the communication network, and transmits the information of the overload-released area to the policy agent installed in the wireless terminal 300. And, the policy agent releases the policy for blocking the network usage for one or more applications in the wireless terminal.

Also, the policy server 100 connects the identification information of the wireless terminal 300 with the identification information of the policy agent, and stores the connected identification information into a storage medium 130 or a database. And, the policy server 100 transmits identification information of one or more applications allowed the network usage irrespective of the position within the overloaded area at the specific time slot to the policy agent installed in the wireless terminal 300.

The communication server 200 according to the embodiment of the present invention relays data communication between the wireless terminal 300 and an application server, checks an area with communication problems caused by overload at the specific time slot, and then transmits information of the overloaded area at the specific time slot to the policy server 100. And, the communication server 200 checks the overload-released area in which the overload is released at the specific time slot, and then transmits information of the overload-released area at the specific time slot to the policy server 100.

The wireless terminal 300 according to the embodiment of the present invention, including the policy agent, performs the network connection to the application server, and stores the received information of the overloaded area at the specific time slot into a storage section by using the policy agent. And, after checking whether the current time and position information correspond to the time and position corresponding to the overloaded area at the specific time slot stored in the storage section, the policy agent blocks network connection of one or more applications installed in the wireless terminal 300 in case the checked time and position correspond to the overloaded area at the specific time slot stored in the storage section.

According to the present invention, the wireless terminal 300, in case the policy agent receives overload releasing information of the overloaded area at the specific time slot, stores the information of the overload-released area at the specific time slot into the storage section or updates the information of the overloaded area at the specific time slot in the storage section. And, after checking whether the current time and position information are deviated from the specific time slot or positioned in the overload-released area, the policy agent releases the network connection blocking of one or more applications installed in the wireless terminal in case the checked current time and position correspond to the time deviated from the specific time slot and the overload-released area.

In the process of releasing the network connection blocking of the applications, the wireless terminal 300, not using the information of the overload-released area at the specific time slot received from the policy server 100, directly checks the current time and position in the policy agent, and then checks deviation from the specific time slot or the overloaded area that correspond to the information of the overloaded area at the specific time slot pre-stored in the storage section. According to a result of the checking, in case the current time and position are deviated from the specific time slot or the overloaded area, the network connection blocking for the applications may be released.

Further, the wireless terminal 300 in advance stores the identification information of the applications allowed the network usage irrespective of the position within the overloaded area into a storage section. And, the wireless terminal 300 selects the applications for which the network connections are blocked by checking the identification information pre-stored in the storage section among a plurality of applications using networks on blocking network connection of one or more applications according to the position of the wireless terminal 300 in the overloaded area at the specific time slot.

According to the present invention, the wireless terminal 300 include all terminal apparatuses, capable of wirelessly communicating, such as a mobile phone, a smart-phone, a tablet PC, etc.

The application server 400 according to the present invention transmits and receives data on performing the network connection for the applications installed in the wireless terminal 300.

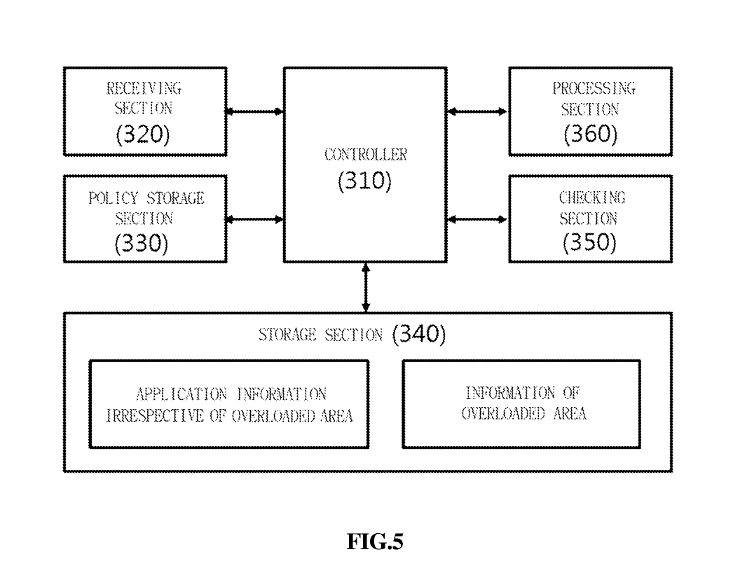

FIG. 4 shows sub-configurations of the policy server 100 according to an embodiment of the present invention.

FIG. 4 shows sub-configurations of the policy server 100 in the system of managing the network load reduction policy, the system being shown in FIG. 3. And, each configuration of the policy server 100 are to describe an embodiment of the present invention, and the present invention is not limited to the embodiment only shown in FIG. 4.

Referring to FIG. 4, the policy server 100 according to the embodiment of the present invention includes a communication section 120, a processing section 130, and a controller 110 for controlling each configuration.

Here, though the policy server 100 is shown as a single server in the drawing for a description of an example, may be composed of one or more separated servers for the each mean or component.

Referring to FIG. 4, the communication section 120 receives information of the overloaded area at the specific time slot and information of the overload-released area at the specific time slot, from the communication server 200 over the communication network.

Here, the information of the overloaded area at the specific time slot may be separated to information of the specific time slot and information of the overloaded area, and the information of the overload-released area at the specific time slot may be separated to information of the specific time slot and information of the overload-released area.

Also, the communication section 120 transmits and receives various information and data with the communication server 200 and the user's wireless terminal 300.

For example, the communication section 140 may transmit identification information of one or more applications allowed the network usage irrespective of the position within the overloaded area at the specific time slot to the policy agent included in the wireless terminal 300.

The processing section 130 according to the present invention processes so that the information of the overloaded area at the specific time slot and the information of the overload-released area at the specific time slot, which is received by the communication section 120, is transmitted to the policy agent included in the wireless terminal 300.

Also, the processing section 130 processes so that the identification information of the application allowed the network usage irrespective of the position within the overloaded area at the specific time slot is transmitted to the policy agent.

According to the present invention, a whole or a part of the functions of each component included in the policy server 100 may be implemented in a program or program set.

FIG. 5 shows sub-configurations of the wireless terminal 300 according to an embodiment of the present invention.

In more detail, FIG. 5 shows sub-configurations for the wireless terminal 300 shown in FIG.3, each configuration is to describe an embodiment of the present invention, and the present invention is not limited to the embodiment only shown in FIG.5.

Referring to FIG. 5, the wireless terminal 300 according to the embodiment of the present invention includes a receiving section 320, a policy storage section 330, a storage section 340, a checking section 350, a processing section 360, and a controller 310 for controlling each configuration.

Wholly or in part of each configuration of the wireless terminal 300 may be configured in a program type such as policy agent.

Referring to FIG. 5, the receiving section 320 receives information of the overloaded area at the specific time slot from the policy server 100 or the communication server 200.

Here, the information of the overloaded area at the specific time slot may be separated to information of the specific time slot and information of the overloaded area.

According to the present invention, the receiving section 320 further receives information of the overload-released area at the specific time slot, besides the information of the overloaded area at the specific time slot, from the policy server 100 or the communication server 200. And, the receiving section 320 further receives information of one or more applications allowed the network usage irrespective of the position within the overloaded area at the specific time slot, from the policy server 100.

The policy storage section 320 according to the embodiment of the present invention stores the received information of the overloaded area at the specific time slot and information of the overload-released area at the specific time slot into the storage section 340.

Here, when storing the information of the overloaded area at the specific time slot and information of the overload-released area at the specific time slot into the storage section 340, the policy storage section 320 stores the policy information for blocking the network connection of one or more applications, the policy information including at least one of information of applications to be blocked, information of the blocking time and pattern information of networks to be blocked, in connection with the information of the overloaded area at the specific time slot.

According to the present invention, the policy storage section 320 further stores the identification information of the applications allowed the network usage irrespective of the position in the overloaded area at the specific time slot into the storage section 340, the identification information being received by the policy receiving section 340.

The storage section 340 according to the embodiment of the present invention stores and manages the information of the overloaded area at the specific time slot and information of the overload-released area at the specific time slot. And, the storage section 340 stores and manages the policy information for blocking the network connection according to the overloaded area at the specific time slot in connection with the information of the overloaded area at the specific time slot. Also, the storage section 340 stores and manages the identification information of the applications allowed the network usage irrespective of the position in the overloaded area at the specific time slot.

The checking section 350 according to the embodiment of the present invention checks whether information of the current time and position corresponds to the specific time slot and the overloaded area stored in the storage section 340.

Here, the checking section 350 may check the current position information using conventional method for checking position information of a wireless terminal such as GPS information or the base station information over the communication network.

Also, in case the information of the overload-released area at the specific time slot is stored in the storage section 340, or the information of the overloaded area at the specific time slot is updated in the storage section 340, the checking section 350 may check whether the current time and position information are deviated from the specific time slot or positioned in the overload-released area.

Also, the checking section 350 may check deviation from the specific time slot or the overloaded area corresponding to the information of the overloaded area at the specific time slot pre-stored in the storage section 340 by checking the current time and position information.

The processing section 360 according to the embodiment of the present invention blocks network connection of one or more applications installed in the wireless terminal 300, in case the time and position checked by the checking section 350 correspond to the information of the specific time slot and the overloaded area stored in the storage section 340.

And, the processing section 360 releases the network connection blocking of one or more applications installed in the wireless terminal, in case the time and position checked by the checking section 350 correspond to the information of the overload-released area at the specific time slot stored in the storage section 340.

Also, the processing section 360 releases the network connection blocking of one or more applications installed in the wireless terminal, in case the current time and position are deviated from the specific time slot or the overloaded area corresponding to the information of the overload-released area at the specific time slot pre-stored in the storage section 340 by checking the current time and position of the wireless terminal 300 in the checking section 350.

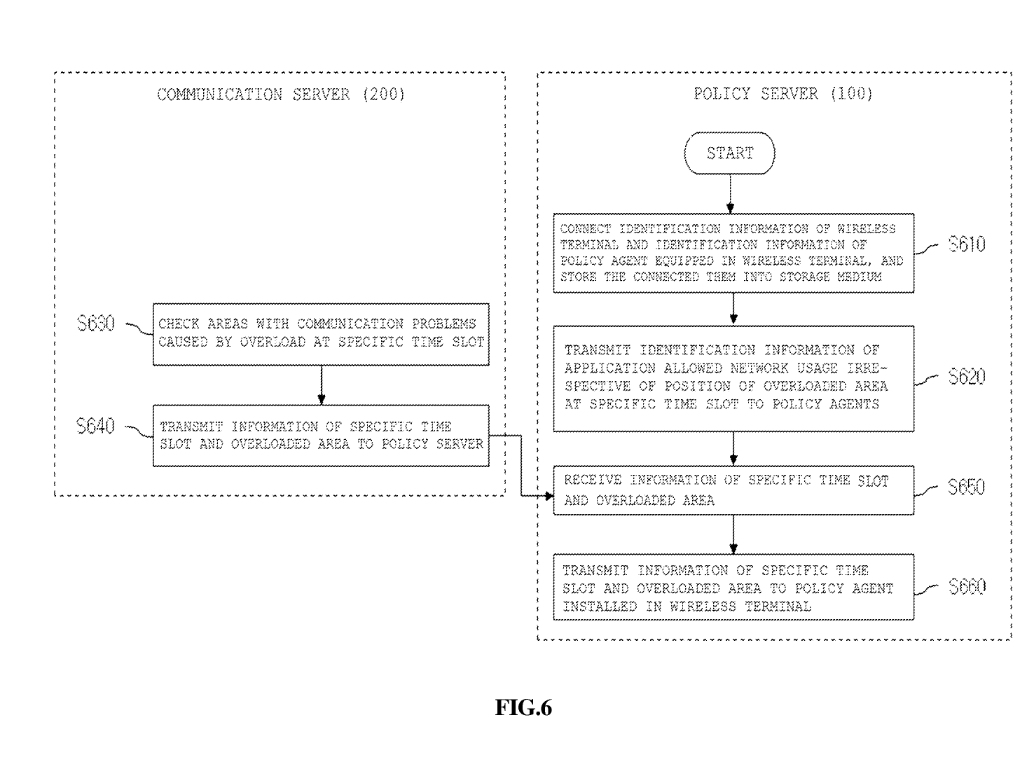

FIG. 6 shows a process for managing the network usage blocking policy in the overloaded area according to the embodiment of the present invention.

Firstly, the policy server 100 connects identification information of a plurality of wireless terminals 300 and identification information of the policy agents installed in the plurality of wireless terminals 300 and therefore stores the connected them into the storage medium 130, by using the storage section 130 (S610).

Then, the policy server 100 transmits identification information of one or more applications allowed the network usage irrespective of the position in the overloaded area at the specific time slot to the policy agents installed in the wireless terminal 300 by using the processing section 150, and the policy agent stores the identification information of the applications allowed the network usage irrespective of the position in the overloaded area at the specific time slot into the storage section (S620).

Orders for the steps S610 and S620 may be changed, and the steps may be omitted with intentions of those skilled in the art.

The communication server 200 according to the present invention checks areas generated with communication problems caused by overload at the specific time slot over the communication network (S630), and then transmits information of the specific time slot and the area in which the overload occurs to the policy server 100 (S640).

The policy server 100 receives the information of the specific time slot and the overloaded area through the communication section 120 (S650), and then transmits the received information of the specific time slot and the overloaded area to the policy agent installed in the wireless terminal 300 (S660). Therefore, the policy agent blocks the network connection of one or more applications in the wireless terminal, in case the current time and position correspond to the specific time slot and the overloaded area.

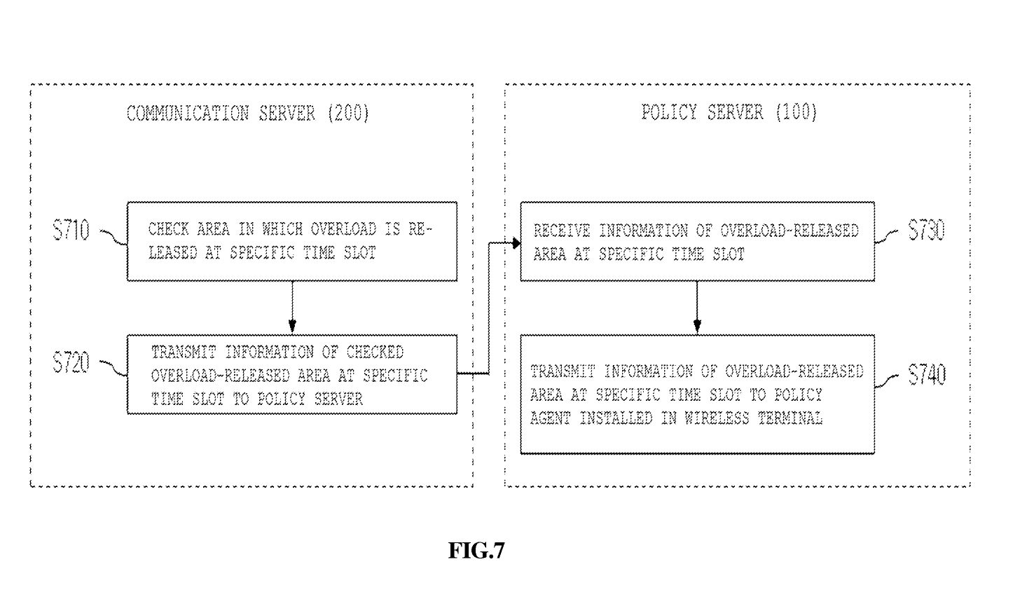

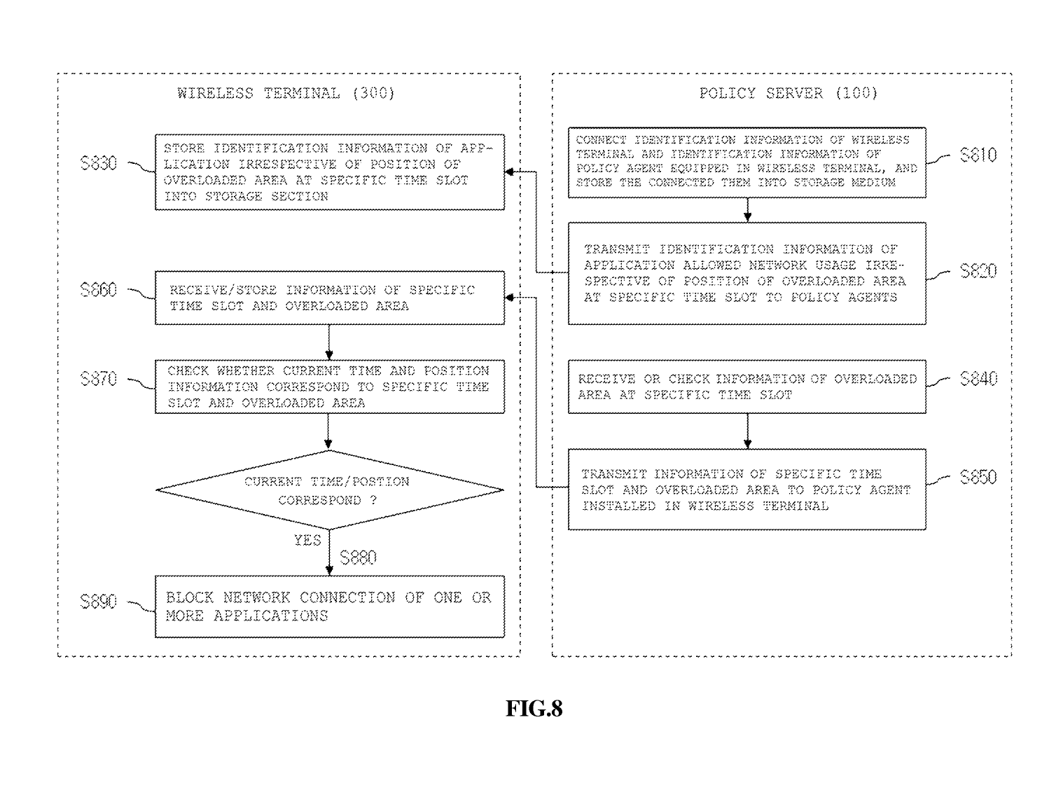

FIG. 7 shows a process of managing a policy for releasing the network usage blocking in the overload-released area at a specific time slot according to the embodiment of the present invention.

The communication server 200 according to the present invention checks the overload-released area at the specific time slot (S710), and then transmits information of the overload-released area at the specific time slot to the policy server 100 (S720).

The policy server 100 receives the information of the overload-released area at the specific time slot from the communication server 200 through the communication section 120 (S730), and then transmits the received information of the overload-released area at the specific time slot to the policy agent installed in the wireless terminal 300 (S730). Therefore, the policy agent releases the network connection blocking policy for one or more applications in the wireless terminal.

FIG. 8 shows a process of blocking the network connection for the wireless terminal positioned in the overloaded area at the specific time slot, according to the embodiment of the present invention.

Firstly, the policy server 100 connects identification information of a plurality of wireless terminals 300 and identification information of the policy agents installed in the plurality of wireless terminals 300 and therefore stores the connected them into the storage medium (S810).

Then, the policy server 100 transmits identification information of one or more applications allowed the network usage irrespective of the position in the overloaded area at the specific time slot to the policy agents installed in the wireless terminal 300, and the policy agent stores the identification information of the applications allowed the network usage irrespective of the position in the overloaded area at the specific time slot into the storage section 340 (S820).

Orders for the steps S810 and S820 may be changed.

Here, the wireless terminal 300 receives the identification information of one or more applications allowed the network usage irrespective of the position in the overloaded area at the specific time slot, and stores the identification information received from the policy server 100 into the storage section 340 (S830).

Afterward, the policy server 100 receives the information of the overloaded area at the specific time slot from the communication server 200, or directly checks the information of the overloaded area at the specific time slot (S840). And then, the policy server 100 transmits the information of the overloaded area at the specific time slot to the policy agent installed in the wireless terminal 300 (S850).

The policy agent in the wireless terminal 300 receives the information of the overloaded area at the specific time slot from the policy server 100 and stores the received information into the storage section 340 (S860)

And, the policy agent in the wireless terminal 300 checks whether the current time and position of the wireless terminal 300 correspond to the specific time slot and the overloaded area stored in the storage section 340 (S870)

Then, in case the current time and position of the wireless terminal 300 correspond to the specific time slot and the overloaded area stored in the storage section 340 according to a result of checking in the step of 5870 (S880), the policy agent in the wireless terminal 300 blocks the network connection for all applications except the checked applications corresponding to the identification information pre-stored in the storage section 330 among the plurality of applications using the network, based on the received policy information for blocking the network usage (S890).

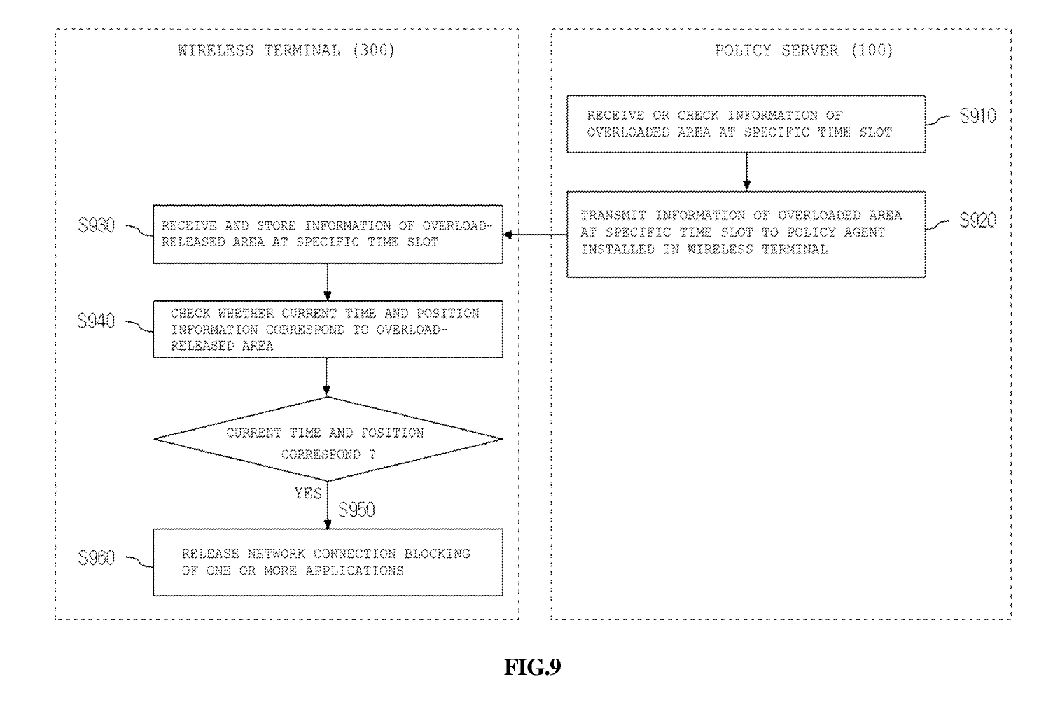

FIG. 9 shows a process of releasing the network connection blocking for the wireless terminal positioned in the overload-released area, according to the embodiment of the present invention.

Firstly, the policy server 100 according to the present invention receives from the communication server or directly checks the information of the overload-released area at the specific time slot (S910).

Afterward, the policy server 100 transmits the information of the overload-released area at the specific time slot to the policy agent installed in the wireless terminal (S920).

The policy agent installed in the wireless terminal 300 receives the information of the overload-released area at the specific time slot from the policy server 100 and stores the received information into the storage section 340 (S930).

Afterward, the policy agent installed in the wireless terminal 300 checks whether the current time and position of the wireless terminal 300 correspond to the specific time slot and the overload-released area stored in the storage section 340 (S940).

Then, in case the current time and position of the wireless terminal 300 correspond to the specific time slot and the overload-released area stored in the storage section 340 according to a result of checking in the step of S940 (S950), the policy agent in the wireless terminal 300 releases the network connection blocking for applications (S960).

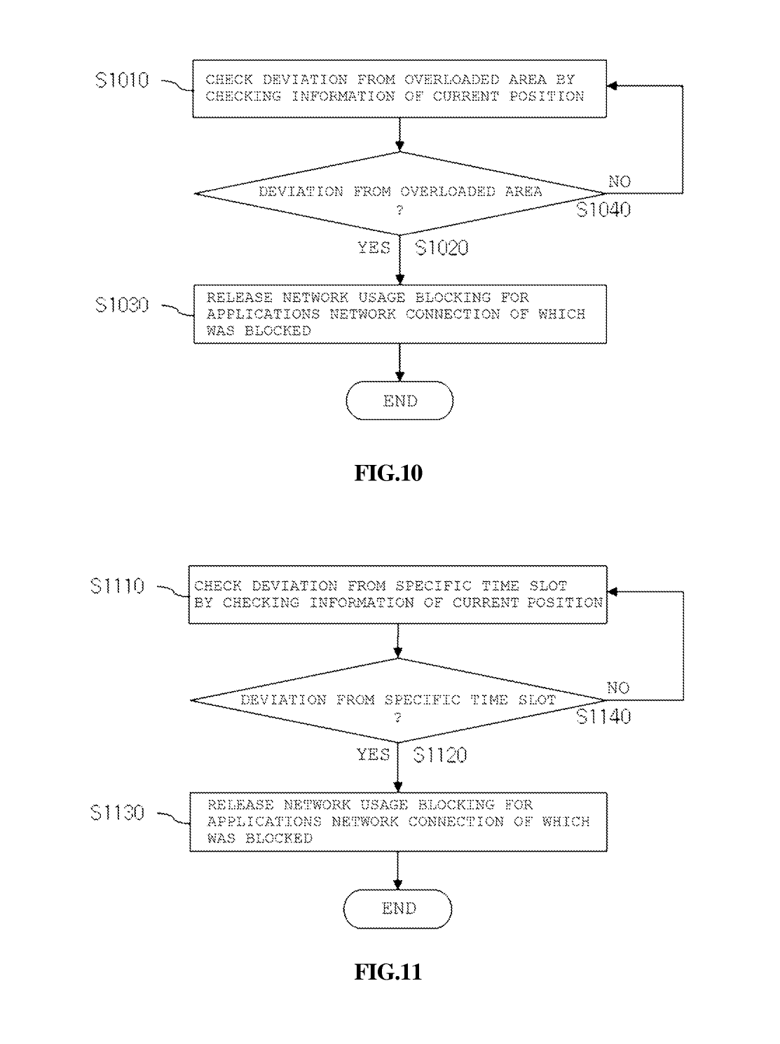

A process for the case of autonomously determining releasing of the network usage blocking without the information of the overload-released area received from the policy server 100 is described in FIGS. 10 and 11.

FIG. 10 shows a process of releasing the network connection blocking for the wireless terminal deviated from the overloaded area at the specific time slot, according to another embodiment of the present invention.

In case of autonomously determining releasing of the network usage blocking without the information of the overload-released area at the specific time slot received from the policy server 100, the policy agent in the wireless terminal 300 checks the current position information of the wireless terminal 300 using GPS information or the base station information (S1010).

In case the current time and the current position information checked in the step of S1010 are deviated from the overloaded area (S1020), the policy agent of the wireless terminal 300 releases the network connection blocking for the applications for which the network connection was blocked according to the position within the overloaded area (S1030).

In case the current time and the current position information checked in the step of S1010 does not correspond to the position deviated from the overloaded area (S1040), the policy agent of the wireless terminal 300 repeats the step of S1010.

FIG. 11 shows a process of releasing the network connection blocking for the wireless terminal deviated from the specific time slot, according to the other embodiment of the present invention.

In case of autonomously determining releasing of the network usage blocking without the information of the overload-released area at the specific time slot received from the policy server 100, the policy agent in the wireless terminal 300 checks deviation from the specific time slot by checking the current time information (S1110).

In case the current time information checked in the step of S1110 is deviated from the specific time slot (S1120), the policy agent of the wireless terminal 300 releases the network connection blocking for the applications for which the network connection was blocked according to the position within the overloaded area (S1130).

In case the current time information checked in the step of S1110 is included in the specific time slot (S1140), the policy agent of the wireless terminal 300 repeats the step of S1110.

In addition, the above-described present invention may be implemented as a program executable in a computer and may be stored in a computer-readable recording medium; examples of the computer-readable recording medium may be ROM, RAM, CD-ROM, Magnetic Tape, Floppy Disk, Optical Data Storage, etc., including carrier wave (e.g., transmission through internet).

The computer-readable recording medium may be distributed to a computer systems connected in a network, so that the computer-readable code may be stored and executed in a distributed mode. Also, functional program, code and code segments for implementing the controlling method may be inferred easily by programmers who skilled in the art of the present invention.

In the above, preferred embodiments of the present invention have been described. However, these embodiments are merely examples and do not limit the present invention, so that persons who skilled in the art of the present invention may easily transform and modify within the limit of the technical spirit of the present invention. For example, each of the components shown in detail in the embodiments of the present invention may be implemented in transformation. In addition, the differences relating these transformations and modifications shall be regarded to be included in the scope of the present invention as defined in the attached claims of the present invention.

1-18. (canceled)

19. A wireless terminal having a function for reducing a network load in an overloaded area, comprising:
a receiving section for receiving information of an area where overload occurs from a server over a communication network; and
a processing section for blocking network connection of one or more applications installed in the wireless terminal, in case a position of the wireless terminal corresponds to the received information of the overloaded area.

20. A wireless terminal having a function for reducing a network load in an overloaded area according to claim 19, further comprising:
a storage section for storing the received information of the overloaded area.

21. A wireless terminal having a function for reducing a network load in an overloaded area according to claim 19, wherein the receiving section receives identification information of one or more applications allowed the network usage irrespective of the position within the overloaded area from the server.

22. A wireless terminal having a function for reducing a network load in an overloaded area according to claim 21, wherein the processing section blocks network connection of all applications except the applications allowed the network usage irrespective of the position within the overloaded area.

23. A wireless terminal having a function for reducing a network load in an overloaded area according to claim 19, wherein the processing section blocks attempt call for network connection of the applications installed in the wireless terminal positioned in the overloaded area.

24. A wireless terminal having a function for reducing a network load in an overloaded area according to claim 19, wherein the processing section blocks at least one of foreground connection and background connection of the applications installed in the wireless terminal positioned in the overloaded area.

25. A wireless terminal having a function for reducing a network load in an overloaded area according to claim 19, wherein the receiving section receives information of an area where overload is released from the server.

26. A wireless terminal having a function for reducing a network load in an overloaded area according to claim 25, wherein the processing section releases the network connection blocking of the applications, in case the position of the wireless terminal corresponds to the received information of the overload-released area.

27. A wireless terminal having a function for reducing a network load in an overloaded area according to claim 19, wherein the processing section releases the network connection blocking of the applications, in case the position of the wireless terminal is deviated from the overloaded area.

28. A wireless terminal having a function for reducing a network load in an overloaded area according to claim 19, wherein the receiving section further receives time information from the server, and
the processing section blocks network connection of one or more applications installed in the wireless terminal, in case the current time corresponds to the received time information.

29. A wireless terminal having a function for reducing a network load in an overloaded area according to claim 28, wherein the processing section releases the network connection blocking for the applications installed in the wireless terminal, in case the current time passes a specific time corresponding to the received time information.

30. A method for reducing a network load of an overloaded area in a wireless terminal, comprising:
receiving information of an area where overload occurs from a server over a communication network;
comparing a position of the wireless terminal with the received information of the overloaded area; and
blocking network connection of one or more applications installed in the wireless terminal, in case a position of the wireless terminal corresponds to the received information of the overloaded area according to a result of the checking.

31. A method for reducing a network load of an overloaded area in a wireless terminal according to claim 30, further comprising:
receiving identification information of one or more applications allowed the network usage irrespective of the position within the overloaded area from the server.

32. A method for reducing a network load of an overloaded area in a wireless terminal according to claim 31, wherein the blocking blocks network connection of all applications except the applications allowed the network usage irrespective of the position within the overloaded area.

33. A method for reducing a network load of an overloaded area in a wireless terminal according to claim 30, further comprising:
receiving information of an area where overload is released from the server;
comparing a position of the wireless terminal with the received information of the overload-released area; and
releasing the network connection blocking for the applications, in case a position of the wireless terminal corresponds to the received information of the overload-released area according to a result of the checking.

34. A method for reducing a network load of an overloaded area in a wireless terminal according to claim 30, further comprising:
releasing the network connection blocking of the applications, in case the position of the wireless terminal is deviated from the overloaded area.

35. A method for reducing a network load of an overloaded area in a wireless terminal according to claim 30, wherein the receiving receives time information for the network connection blocking from the server.

36. A method for reducing a network load of an overloaded area in a wireless terminal according to claim 35, wherein the blocking blocks network connection of one or more applications installed in the wireless terminal, in case the current time corresponds to the received time information.

37. A method for reducing a network load of an overloaded area in a wireless terminal according to claim 35, further comprising:
releasing the network connection blocking for the applications, in case the current time passes a specific time corresponding to the received time information.

38. A computer-readable recording medium for recording programs to perform a method of claim 30.
